(19) United States
(12) Patent Application Publication
(10) Pub. No.: US 2015/0149371 A1
(43) Pub. Date: May 28, 2015

(54) System And Method For Generating And Formatting Formally Correct Case Documents From Rendered Semantic Content

(71) Applicant: Red Ball Express, LLC, Brooklyn, NY (US)

(72) Inventors: Chhi'mèd Künzang, Rancho Palos Verdes, CA (US); Stephen DeRosa, Brooklyn, NY (US)

(73) Assignee: Red Ball Express, LLC, Brooklyn, NY (US)

(21) Appl. No.: 14/092,596

(22) Filed: Nov. 27, 2013

(51) Int. Cl. G06Q 50/18; G06F 17/24; G06F 17/21; G06F 17/22

(52) U.S. Cl. CPC G06Q 50/18; G06F 17/2247; G06F 17/248; G06F 17/211
USPC 705/311

(57) ABSTRACT

A case document generating method implemented by a computer processor for automatically generating formally correct case documents within an electronic network connecting a plurality of desktop and mobile clients to the computer processor. The method including presenting a user interface over the electric network for inputting information on a legal proceeding and for generating a case document in conjunction with the legal proceeding, receiving information on the legal proceeding inputted into the user interface including the venue of the legal proceeding, generating an HTML file version of the case document using information inputted into the user interface, selecting a formatter to be applied to the HTML file version of the case document based on the venue for the legal proceeding, applying the selected formatter to the HTML file version of the case document to generate a formatted HTML file version of the case document, selecting a template to be applied to the formatted HTML file version of the case document and applying the selected template to the formatted HTML file version of the case document to generate a formally correct PDF file version of the case document.

### FIELD OF THE INVENTION

The present invention relates to a system and method for generating and formatting formally correct case documents from rendered semantic content.

### BACKGROUND OF THE INVENTION

The process of generating case documents which comport in appearance and format with the rules of a venue for a legal proceeding as well with attorney preferences is both time-intensive and labor-intensive, involving substantial attention to text formatting, text location, and table generation. The present invention seeks to remedy the above-described problems by automating certain aspects of this process.

### DEFINITIONS

The following definitions are provided for convenience and are not to be taken as a limitation of the present invention.

Legal proceeding refers to an action or proceeding instituted in a court of law, arbitration forum, administrative tribunal or any other adjudication forum.

Venue for a legal proceeding refers to traditional courts of law as well as alternatives to the traditional courts of law including but limited to arbitration panels and administration tribunals.

Case documents refer to any documents generated in conjunction with a legal proceeding which must adhere to formatting and content rules of a venue for the legal proceeding whether filed directed with the venue or with a party related to the legal proceeding.

### SUMMARY OF THE INVENTION

It is the primary purpose of the present invention to obviate the above problems by providing a system and method for generating and formatting formally correct case documents from rendered semantic content.

To accomplish this objective, according to one embodiment of the present invention, a case document generating system for generating case documents in conjunction with a legal proceeding such that the generated case documents are formally correct according to the rules of a venue for the legal proceeding is disclosed. The system comprising a computer processor configured for managing the generation of case documents including a web services module, a document renderer module, a document publishing module and a document archiving module and a database coupled to and configured to cooperate with the computer processor to store and retrieve the case documents and any components comprising or relating to the case document. The web service module providing for a web based editor that provides for the opening of a case document existing in the database, creating a new case document in the database, editing the case document and saving the case document in the database as an HTML file along with any components comprising or relating to the case document. The document renderer module providing for the rendering of the HTML file version of the case document into a final PDF file version of the case document file that is formally correct in accordance with the rules of the venue for the legal proceeding. The document publishing module providing for delivery of the final PDF file version of the case document which the user may download or which may be electronically filed directly with the venue of the legal proceeding or with a party related to the legal proceeding. Lastly, the document archiving module providing for the long term storage and retrieval of the case document, including the final PDF file version of the case document, the HTML file version of the case document and any components comprising or relating to the case document.

In addition to the foregoing, other features, objects and advantages of the present invention will become apparent from the following description.

### BRIEF DESCRIPTION OF THE DRAWINGS

The following detailed description, given by way of example and not intended to limit the present invention solely thereto, will best be appreciated in conjunction with the accompanying drawings, in which:

FIG. 1 is a functional block diagram of a computing system configured for generating and formatting formally correct case documents from rendered semantic content according to the present invention;

FIG. 2 is a functional block diagram of a system infrastructure for implementing a system and method for generating and formatting formally correct case documents from rendered semantic content according to the present invention;

FIG. 3 is a functional block diagram depicting a functional flow diagram of a method for generating and formatting formally correct case documents from rendered semantic content according to the present invention;

FIG. 4 is a representation of a graphical user interface for a web based editor implemented by a method for generating and formatting formally correct case documents from rendered semantic content according to the present invention;

FIG. 5 is a functional block diagram depicting the implementation of a formatter in a method for generating and formatting formally correct case documents from rendered semantic content according to the present invention; and

FIG. 6 is a functional block diagram depicting the generation and application of stylesheets to content within a case document in a method for generating and formatting formally correct case documents from rendered semantic content according to the present invention.

### DETAILED DESCRIPTION OF THE INVENTION

The present invention relates to a system and method for generating and formatting formally correct case documents from rendered semantic content.

The drawings and written description of the present invention are not presented to limit the scope of the claimed invention. Rather, the drawings and written description are provided to teach a person of reasonable skill in the art to make and use the claimed invention. Those skilled in the art will appreciate that for the sake of clarity and understanding not all features of a commercial embodiment of the claimed invention are shown and described. Moreover, a person of reasonable skill in the art will appreciate that the development of a commercial embodiment incorporating aspects of the claimed invention will require numerous implementation-specific decisions. Irrespective of how complex or time consuming the development of these implementation-specific decisions are, such efforts would be a routine undertaking for those skilled in the art having the benefit of this disclosure.

Particular embodiments of the claimed inventions are described with reference to functional block diagrams and operational illustrations of systems and methods. It is understood that each block of a diagram or illustration, as well as a combinations of blocks, may be implemented by analog means, digital hardware means or by the implementation of computer program instructions, or any combination thereof. The computer program instructions may be executed on a single central processor or across multiple central processor units, or the combination thereof. The computer program instructions may be designed as a stand-alone software package or as modules executed as part of another software package. The central processing units implementing the software package may be part of a general purpose computer, a special purpose computer, a cloud based system, an application specific integrated circuit or any other programmable processing system. Moreover, in alternate implementations of the claimed invention, the functions, action and structures may occur out of the specific order sequences disclosed herein. In view of the foregoing, embodiments of the present invention are described in the following drawings and written description.

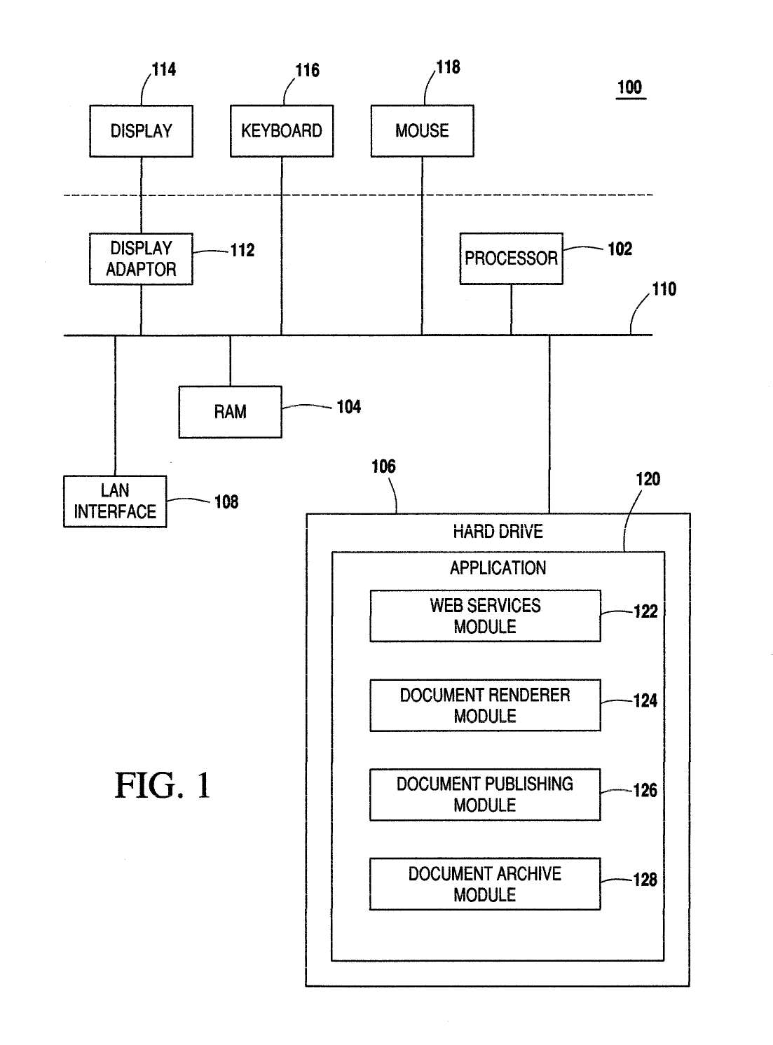

In FIG. 1, a functional block diagram of a computing system configured to generate and format formally correct case documents from rendered semantic content according to the present invention, is illustrated. A set of computer readable instructions comprising an application program 120 is made accessible to a computing system 100 which, when operated upon, implements a method for generating and formatting formally correct case documents. The computing system 100 includes a processor 102 which implements a known operating system and executes the application program 120.

The computing system 100 also includes short term memory 104, preferably random access memory (RAM), and long term memory 106, preferably a hard drive. The computing system 100 further includes a local area network (LAN) interface 108, a communication bus 110, a display adapter 112, a display 114, a keyboard 116 and a mouse 118.

As shown in FIG. 1, the application program 120 for generating and formatting formally correct case documents may be stored in the long term memory 106 and accessed by the processor 102 which executes the computer readable instructions comprising the application program 120. However, the application program 120 may also be stored in the short term memory 104 or any other known form of memory accessible to the processor 102.

The application program 120 may be comprised of computer readable instructions that define functional application modules that may include a web services module 122, a document renderer module 124, a document publishing module 126 and a document archive module 128. The web services module 122 provides for a web based interface used by clients to generate and format case documents. The document renderer module 124 creates and applies stylesheets so as to create formally correct case documents. The document publishing module 126 provides for the rendering of final PDF file version of the case document. The document archive module 128 provides for the long term storage and retrieval of final PDF file versions and HTML file versions of case documents and any components comprising or relating to an archived case document.

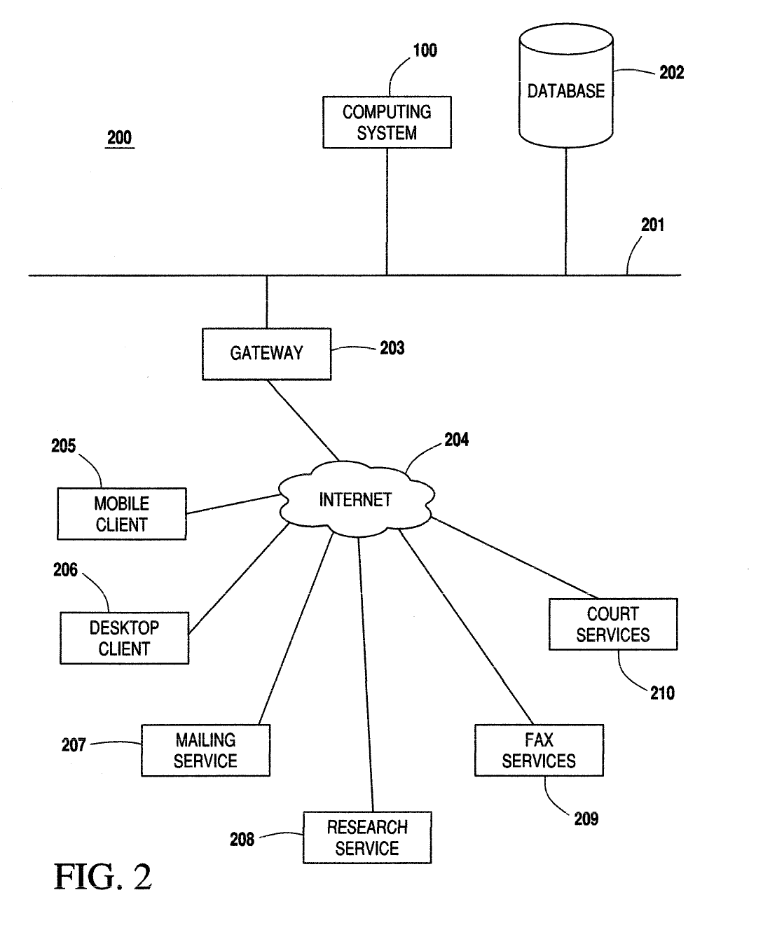

In FIG. 2, a functional block diagram of a system for implementing a system and method for generating and formatting formally correct case documents from rendered semantic content according to the present invention, is illustrated. As shown in FIG. 2, the system 200 includes a local area network (LAN) 201 interconnecting the computing system 100 with a database 202, preferably a relational database, and a gateway 203 that provides access to a global area network 204 such as the Internet.

While the database 202 is represented as a conventional database comprising a fixed storage medium, the database may also be distributed across the local area network 201, across off-network locations, such as a cloud based database, or across some combination of inter-network and intra-network locations. Alternatively, the database may reside in storage means directly accessible to the computing system 100. Moreover, while the LAN 201 is shown operating within a hardwired based network, it may also operate within a wireless network in accordance with a corresponding wireless protocol and wireless network controllers.

The global area network 204 provides a backbone for connecting remote clients to the computing system 100 via the gateway 203. These remote clients may include a court service 210, a fax service 209, a research service 208, a mailing service 207, a desktop client 206 and a mobile client 205.

The court service 210 may be any court system that provides for the electronic filling and retrieval of legal documents, non-legal documents and specific case information. The fax service 209 may be any service that provides for the telephonic transmission of electronically uploaded documents. The research service 208 may be any service that provides for on-line access to legal research databases and on-line retrieval of citations, these services including WESTLAW, LEXISNEXIS and GOOGLE SCHOLAR. The mailing service 207 may be any service that prints uploaded documents and that mails the printed documents via a standard mail carrier service using provided mailing addresses, this service including the US POSTAL SERVICE. The desktop client 206 may be any web browser enabled desktop client from which a registered user may access the computing system 100 via the web services module 122. Similarly, the mobile client 205 is any web browser enabled mobile client from which a registered user may access the computing system 100 via the web services modules 122.

The mobile client 205 does not necessarily need to be web browser enabled, though in practice any mobile client most likely will be. A browser-based solution allows for the simplest implementation, but a native (non-browser-based) implementation of the interface which communicates with the computing system 100 is also possible and within the scope of the present invention. The same is true for the desktop client 206.

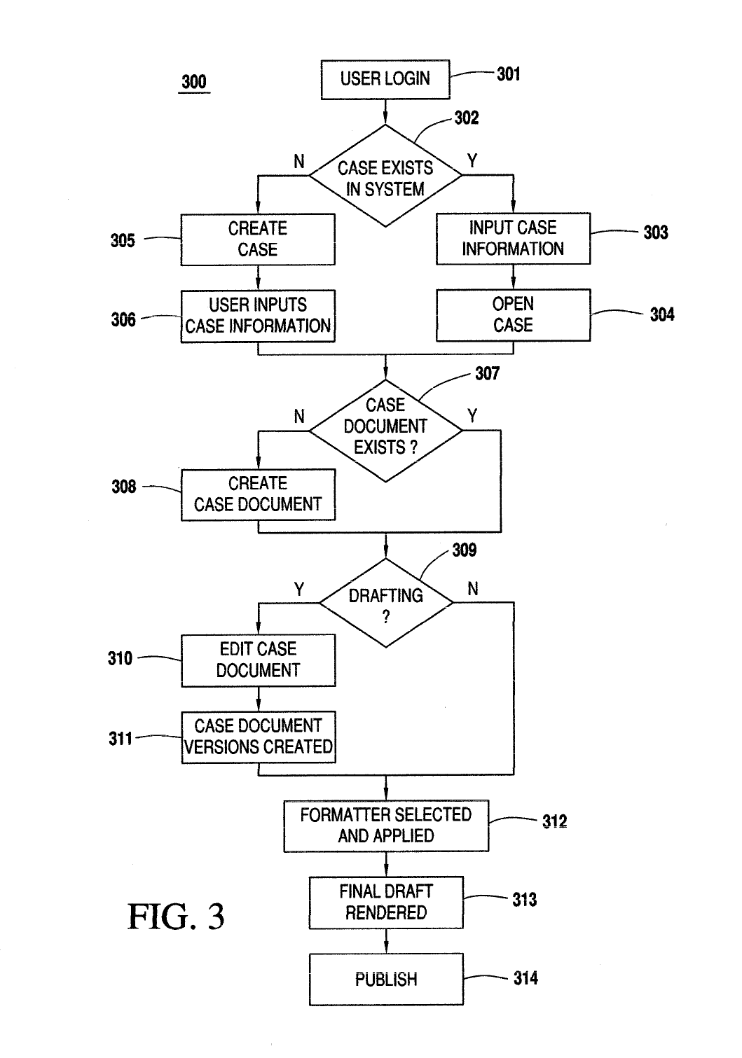

In FIG. 3, a functional flow diagram of a method for generating and formatting formally correct case documents from rendered semantic content according to the present invention, is illustrated. As shown in FIG. 3, the method 300 begins, in step 301, with a user login into the system 200 using any known means of authentication including a username and password combination. Once logged in, in step 302, the user determines whether or not a case of interest already exists within the system 200.

If the user determined that the case already exists within the system 200, in step 303, the case information is inputted into the system 200 by the user. The case information may include the case name, the case number and the specific venue before which the legal proceeding will be heard. The case information may also include the parties and their associated attorneys as well each party's category, the party categories including defendant, plaintiff or any other category definition appropriate for the specific legal proceeding. For each included party category there is a corresponding list of parties and associated attorneys. The same party may appear within multiple party categories and may have a different associated attorney for each party category. Specific attorney information may include name, title, bar number, email address, service type, firm name and signatory designation. An attorney's firm information may include name, mailing address, webpage address, telephone number and fax number. Once the case information has been inputted, in step 304, it is used by the system 200 to retrieve any existing case documents from the database 202.

Alternatively, if the case does not yet exist, in step 305, a case is created in the database 202. Once the case has been created, in step 306, the user inputs case information corresponding to the newly created case and the inputted case information is saved along with the newly created case. As an alternative to a user manually imputing case information, the case information may be imported from an external source and then amended as needed by the user. As an example, an existing account in an external source, such as PACER, may be used to look up case information using a combination of court, district and case number information. If available, all case information is gathered using any known method, including screen scraping and parsing of gathered information or a structured API request provided by the external source.

Once an existing or newly created case has been opened, in step 307, it is determined whether or not a case document exists for that particular case. If a case document does not exist, an initial case document is created in step 308. A newly created case document requires only a title but may also include other appropriate metadata type information such legal proceeding type, hearing data, trial date, venue designation and assigned judge or arbitrator. The initial case document and any provided metadata information are stored in the database 202 and the case document is opened in a web based editing interface. The case document file itself is stored under a filing in the database 202, the filing being akin to a directory with each case including one or more filings. If a case document already exists, the user may select to open an existing case document stored within one of the filings of the case.

Once a case document has been opened, in step 309, it is determined whether or not the user is still in the drafting phase. If it is determined that the user is still drafting the case document, in step 310, the case document is opened in a web based editor running on a desktop client 206 or a mobile client 205. The web based client provides for inserting, removing and editing of actual text within the opened case document as well as the inserting, removing and editing of semantic tags to identify and categorize text within the case document.

While the case document is still being drafted, in step 311, versioning of the case document currently opened within the web based editor is implemented. A case document may have several associated drafts, each draft containing both text and semantic tags. Each draft of the case document is saved in a selected filing of the case in the database 202 with a title that includes three version numbers separated by periods (i.e., “1.2.3”). These numbers represent a major version number, a base version number and a minor version number (i.e., “major version”. “base version”. “minor version”). Whenever a new draft of the case document is created, a new version number is created by incrementing a specific version component number until an unused version number is found. Which version component number is incremented depends on the action that triggers the creation of a new case document draft. Specifically, if a new draft is created by a periodic auto-save function for a case document draft currently opened within the web editor whose content has changed since that draft was last saved, the minor version number is incremented. If a new draft is created by the user explicitly saving the currently opened case document, either by clicking a save button or using a keyboard command, the base version number is incremented. Lastly, if the user explicitly marks the opened draft as a new version of the case document, the major version number is incremented.

Once the user has finished drafting a case document, in step 312, a formatter is selected and applied to the case document. A formatter operates upon the presentation of a case document file by affecting both the content and the formatting of the content within that case document file. A specific formatter is selected to satisfy a set of rules of a designated venue for a legal proceeding as to the content and format of a case document generated in conjunction with that legal proceeding. The selected formatter will operate on an HTML file version of the case document to ensure that a subsequently generated PDF file versions of the case document include the content and formatting necessary to make that case document formally correct according to the rules of the venue for the legal proceeding.

Formatters contain methods and stylesheets, each specific to the particular formatter. The methods within a particular formatter are derived by combining the methods associated with the parent and other ancestors of that particular formatter. Similarly, stylesheets within a particular formatter are generated based on the formatter type as well as the parent and other ancestors of that particular formatter.

As an example, a base District Court formatter would define certain rules and variables which are common to all United States District Courts. A formatter selected for a particular presentation format would provide customization by overriding the default values of some of those variables or overriding some of the default rules included within the base formatter. Similarly, additional variables and rules may be added to the selected formatter. The resulting formatter would include methods and stylesheets which may be used for all filings within a specific U.S. District Court grouping.

The application of a selected formatter will affect the actual content within the HTML file version of a case document. Specifically, using content and semantic tags within the HTML file version of the case document, the formatter will generate and add semantically derived content not currently within the case document. The semantically derived content may include a Table of Contents, a Table of Authorities and concrete text from citation references. Moreover, the formatter will generate caption pages, header and footer information and a signature block in accordance to the requirements of a particular venue for the legal proceeding and insert this content into the case document using a format required by that venue.

Furthermore, the selected formatter will affect the presentation format of the content within HTML file version of the case document. Specifically, the formatter will generate and select one or more stylesheets that are to be applied to the HTML file version of the case document in a manner that mirrors the hierarchy of the formatters themselves.

Similarly, the formatter will generate a stylesheet for the citations within the HTML file version of the case document according to a selected citation standard such as the BLUE BOOK citation standard.

As such, formatters will generate an augmented HTML file version of the case document as well as one or more stylesheets that will be applied to the content and citations within that HTML file version of the case document. In step 313, the one or more stylesheets are applied to the HTML file version of the case document to create a formatted case document HTML file. The formatted case document HTML file is then passed through a PDF renderer to create a final PDF file version of the case document. At this point, information only available after typesetting is captured and used for final adjustments to the content and layout of the final PDF file version of the case document, this information including final page numbers for the Table of Authorities and line breaks needed for proper vertical separation within the rendered case document.

Lastly, in step 314, the rendered PDF file version of the case document is published. The rendered PDF file is then downloaded by the user for subsequent submission to the venue for the legal proceeding or to a party related to the legal proceeding. A copy of the rendered PDF file version of the case document is archived and marked as final. If desired, the final case document file is electronically filed with the venue or a related party. Copies of the final case document may be sent to attorneys on a service list based on recorded delivery preference including mail, facsimile or email.

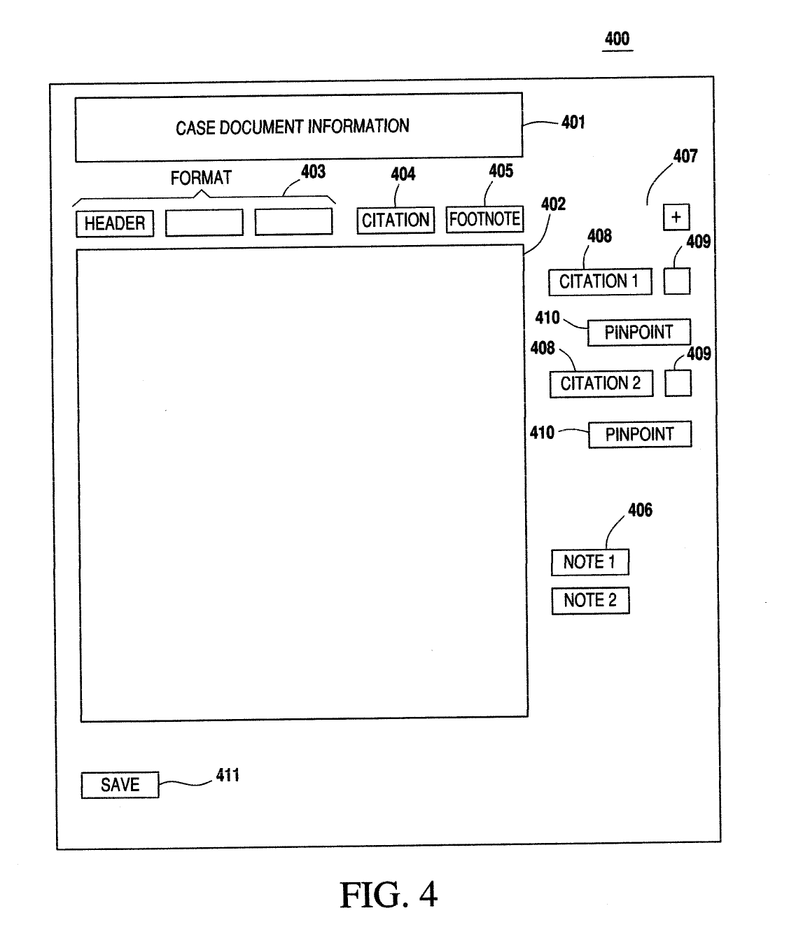

In FIG. 4, an exemplary web based user interface for editing case documents according to the present invention, is illustrated. As shown in FIG. 4, the user interface 400 includes a case document information section 401 and a text body section 402. The case document information section 401 contains relevant information about the case document currently being edited including case document title, title prefix and suffix and optional hearing information. The optional hearing information includes hearing or trial date and time, judge or arbitrator information and assigned venue information.

The text body section 402 contains the actual text of the case document currently being edited. Text may be inserted, removed and edited within the text body section 402 as needed to define the actual content of the case document currently being edited. The text body section 402 provides for the application of standard formatting to selected portions of text. Moreover, semantic information may be inserted, removed and edited to identify and categorize specific text within the text body section 402. The semantic information may include header tags, body text tags, footnote tags and citation tags, these tags being used to subsequently render additional semantic based content necessary to generate a formally correct final draft of the case document. A person of reasonable skill in the art will realize that the scope of the present invention includes any and all semantic information, in addition and including the aforementioned sematic tags, that may be used to render semantic based content necessary to generate a formally correct case document in conjunction with a venue for a legal proceeding.

As shown in FIG. 4, the user interface 400 also includes a grouping of heading tag buttons 403, a citation tag button 404 and a footnote tag button 405. The heading tag buttons 403 provide for the insertion of heading tags to identify specific text portions within the text body section 402 as heading content. There may be multiple heading tag buttons 403 allowing for the selection of different heading levels and types. Moreover, the text body section provides for the modification of heading text as needed.

The citation tag button 404 provides for the insertion of citation tags to identify specific text portions within the text body section 402 as citation content. Given a formatted full-text citation and a citation type, which may or may not be inferred, a citation parser extracts the individual components of the citation. The extracted citation components are used to create a new citation whose fields are populated with the extracted components.

The footnote tag button 405 provides for the insertion of footnote tags to identify specific text portions within the text body section 402 as footnote content. A listing of footnotes 406 is updated each time a footnote tag is added to newly selected or inserted text within the text body section 402. The footnote text may be modified as needed.

As shown in FIG. 4, the user interface 400 also includes a create citation button 407. The create citation button 407 provides for the creation of a citation reference for selected content within the text body section 402. An individual citation 408 is displayed for each created citation reference, each citation including information components necessary for a selected type of reference which are manually populated by the user. Additionally, adjacent to each citation 408 is a pinpoint citation button 409 which provides for the creation of a pinpoint citation 410 for the corresponding citation 408. Each pinpoint citation 410 provides for specifying individual page number within the cited reference.

Lastly, as shown in FIG. 4, the user interface 100 includes a save button 411 which saves the information within the user interface 400 as an HTML file within a filing of the case in the database 202. The HTML file includes both the text defining the content of the case document as well as semantic tags inserted into that text which define and categorize the text within the case document. Citations which have been inserted into the case document are saved to the database 202 and references to the citations saved in the database 202 are inserted into the case document body. Abbreviated names inserted into the case document body and marked as citations are matched against citations already exiting in the database 202 and corresponding references to matched citations in the database are inserted and saved within the case document.

Moreover, full-text citations may also be inserted into the document body using textual notation. These references are parsed, saved into the database 202 if not already there and replaced by a reference to the citation in the database 202. Specifically, in addition to the insertion through the user interface, citations may be added to the content of the case document by the inclusion of tagged text. This allows a user to create an inline citation via a text entry while composing the case document. The tagging system may be used in two distinct ways. Firstly, it may be used as an initial citation entry and creation method. Secondly, it may be used to provide references within the text of the case document to citation document stored in the database 202.

There are four forms of inline citation tags, namely an ID tag, a NAMED tag, a BRACKETED tag and a TYPED BRACKETED tag. Each of these tag forms are distinguished by their function and each can be scanned, detected and substituted using regular expression matching. A person of relative skill in the art will realize that other forms of inline citation may be implemented to accommodate other functions without exceeding the scope of the present invention.

In each inline citation tag form, the citation tag is introduced by a prefix which, in an exemplary implementation, is an asterisk followed by either the character “c” or the word “cite” followed by a colon. Therefore, in our exemplary implementation, the prefixes of a valid citation marker would include “*c:” and “*cite:”. Of course, a person of reasonable skill in the art will understand that any other combination of characters may be used to define a valid citation marker without exceeding the scope of the present invention. All text between the colon and the next whitespace character are included within the inline citation.

An ID tag has characters representing an integer as its content, the integer representing a citation ID number in the database. This tag is used to uniquely identify a citation already existing in the database 202. As an example, the inline citation “cite:123” refers to the citation in the database 202 with the ID number “123.”

A NAMED tag contains text representing the name, or a portion of the name, of a citation reference. If a citation already exists in the database with a name matching the supplied name fragment, this tag represents a reference to the matched citation in the database 202. If no such citation exists in the database, a new citation is created using the provided name fragment. Other components of the newly created citation are left with default values to be edited at a later time. This allows the user to create forward references to citations which have not yet been defined and to continue drafting without having to break the flow of drafting to look up and enter citation information. As an example, “*cite:gore” might refer to a case citation for a case named “Gore v. Bush,” whose specific citation information may be entered into the database 202 at any point in the drafting process.

A BRACKETED tag contains text enclosed in square brackets. The enclosed text represents the full text of the citation to be created or matched. This text must be parsed into the components of the citation, just as when a citation is added through the interactive interface. By default, the bracketed text is assumed to be a case citation. If the parser is able to heuristically determine a citation type other than a case citation based on the text format, a citation of the appropriate type will be created. As an example, “*cite:[Ashcroft v. Igbal, 129 S.Ct. 1937 (2009)]” will be parsed as a case citation by default.

Lastly, a TYPED BRACKETED tag is similar to a BRACKETED tag but also includes an explicit definition of the citation type. The explicit definition appears in parentheses and is followed by the citation's full text enclosed in brackets. For example, “*cite(statute)[Comprehensive Environmental Response, and Liability Act, 42 U.S.C. §§9601-9675(2006)]” is a statute citation defined inline with its full citation text.

When a case document is saved to the database 202, the citation formatter scans the text of the case document for citation tags. Any tags found that are not an ID tag are created in the database, if necessary, and resolved to specific citations existing in the database 202. As such, all tags are converted to ID tags before the case document is saved. Subsequently, before a case document is presented as HTML in a browser by the web services module 122, appropriate HTML is substituted for all citations so they can be formatted correctly within the case document. The formatted citations appear as buttons labelled as citations which can be clicked to edit the citation components. By hovering over the button, the user can see the citation information. Reference to the underlying citation is encoded in the generated HTML by including an ID tag in an HTML attribute.

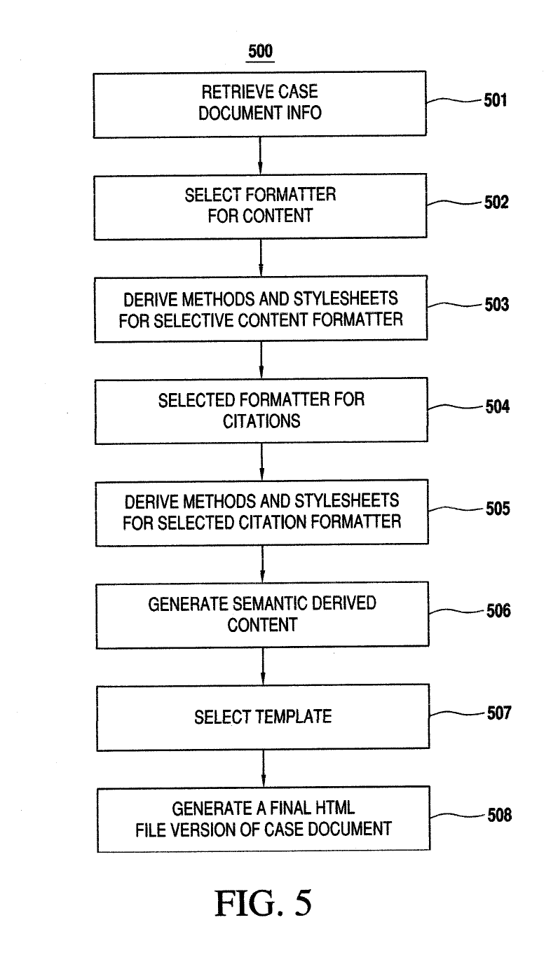

In FIG. 5, a functional flow diagram depicting the implementation of a formatter in a method for generating and formatting formally correct case documents from rendered semantic content according to the present invention, is illustrated. As shown in FIG. 5, the implementation of a formatter 500 begins, in step 501, with the retrieval of the case document information from the database 202.

In step 502, a specific formatter for the content within the case document file is selected based on the specific venue for the legal proceeding for which the case document has been generated. A library of base formatter for each venue may be stored in the database 202.

Once a formatter for content has been selected based on the venue for the legal proceeding for which the case document has been generated, in step 503, the methods and stylesheets that are to comprise the selected content formatter are derived. As described above, the selected formatter is derived by combining the methods of the selected formatter's parent and other ancestor formatters, each of those formatters reflecting the requirements of other venues in the hierarchal chain of the specific venue for which the case document has been generated. The methods included with a formatter include, but are not limited to, performing such function as locating and combining stylesheets, specifying placement of content elements (attorney information in upper left of case document), determining presentation and labeling of content (e.g., “Case No.” or “Civil Action No.”), transformation of content (i.e., party names in upper case), formatting of signature names and signature blocks, formatting of dates and generating default footers from case and document information.

Moreover, the selected formatter includes one or more declarative stylesheet specification files which in combination are interpreted into a final stylesheet for the content within the case document. Which declarative stylesheet specification files are selected for inclusion in the generation of a stylesheet is also determined by the parent and other ancestors of the selected formatter. As such, the selected declarative stylesheet specification files will also reflect the format requirements of the specific venue for the legal proceeding for which the case document where generated as well as the format requirements of the other venues within the hierarchal chain of the specific venue.

Next, in step 304, a specific formatter for citations within the case document is selected based on the venue for the legal proceeding as well as the citation standard that is to be used. Citation formatters provide for the correct formatting of citations within the case document. The correct citation form depends on several factors, including citation type, the actual citation data, the formatter type and the citation placement in the case document. The formatter takes in and combines all these factors and outputs correctly formatted citation text that is inserted into the case document. The citation type refers to whether it is a case citation, a statute citation, a book citation or any other known type of citation. Moreover, all citations can serve as a base citation for an associated pinpoint citation which adds page number references to the base citation. As such, pinpoint citations extend the citation type of the corresponding base citation. The citation formatter type refers to a citation standard used, including the BLUE BOOK standard and the CALIFORNIA STYLE MANUAL standard. The actual citation data refers to the details of the specific citation type. As an example, the actual citation data for a case citation include volume, reporter, case name, page number, year and court. The citation placement refers to where in the case document the citation occurs. As an example, whether the citation is a first reference, a subsequent citation in the same paragraph or a subsequent citation in a later paragraph.

As with the content formatter, once the formatter for citations has been selected based on the venue for the legal proceeding and the citation standard, in step 505, the methods and stylesheets for the selected citation formatter are derived. A citation formatter will take all of these factors into account in determining how a citation is to be presented including punctuation, abbreviation or substitution of words like “id” and “supra.”

Next, in step 506, semantic derived content is generated. The methods within the formatter generate such information as the Table of Contents and the Table of Authorities from existing semantically tagged content within the case document. Moreover, citation references within the case document are substituted with concrete marked-up text, the content and format of the text depending on the placement and type of the citation. The content and citations semantically derived by the methods of the formatter will adhere to the content, citation and format requirements of the specific venue for the legal proceeding for which the case document was generated as well as the preferences of the user generating the case document. The semantically derived content is attached to the HTML file version of the case document for later use.

Next, in step 507, an appropriate template for content rendering is selected based on the selected formatter. The template provides for specific formatting and presentation requirements which need to be applied to the case document after a formatter has been applied to the case document.

Once a specific template has been selected, in step 508, the selected template is executed to render a final HTML file version of the case document. The final case document HTML file integrates the content and semantic tags within the original case document HTML file, the citation reference text within the original case document HTML file and the semantic content derived from the original case document HTML file. Moreover, the template generates a caption page, header and footer content and a signature block which are also integrated into the final case document HTML file. The template also provides for the application of user customization specified during the selection of the formatters. A rendered final HTML file version of the case document is then saved to the database 202.

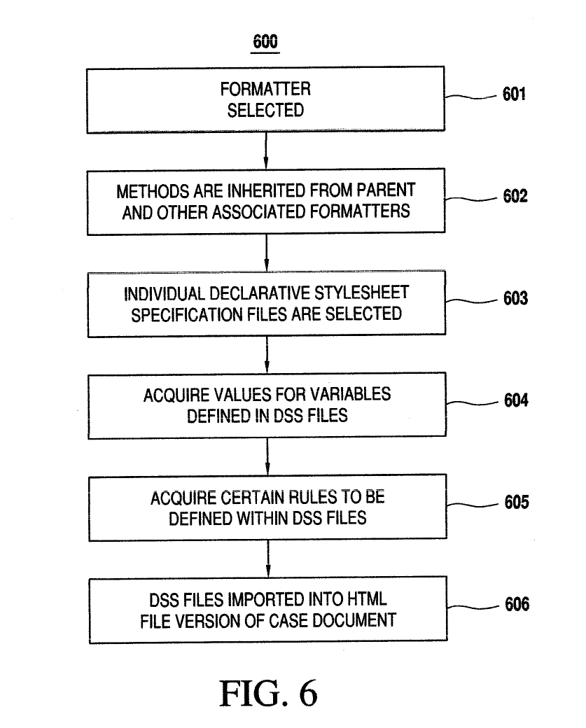

In FIG. 6, a functional flow diagram depicting the generation of stylesheets for content within a case document generated by a method for generating and formatting formally correct case documents from rendered semantic content according to the present invention, is illustrated. As shown in FIG. 6, the generation of a stylesheet begins with the selection of a formatter in step 601. As discussed above, the formatter is selected by the system based on the venue for the legal proceeding for which the case document was generated. The selected formatter defines methods which acquire values and provide custom rules necessary to ensure that the case document is correctly formatted for the specific venue for the legal proceeding. The user may override certain default values as a form of customization or, in cases where the chosen venue has alternate formatters available, the user may select one of the alternate formatters.

An abstract formatter contains a procedural component and a declarative component. The procedural component includes methods that implement an object-oriented class based hierarchy. The declarative component includes declarative stylesheet specification files that implement an inclusion based hierarchy. As an example, the declarative stylesheet specification files may be comprised of a preprocessing language which renders into a stylesheet that is then applied to the HTML file version of the case document. In one exemplary embodiment, if the rendered stylesheet is a CASCADING STYLE SHEET (“CSS”), then the declarative stylesheet specification files may be comprised of SYNTATICALLY AWESOME STYLESHEETS (“SASS”) or LESS based instructions, each of which implements an inclusion based hierarchy.

Once a formatter has been selected, the procedural component of the selected formatter, in step 602, uses an object-oriented hierarchy to inherit methods from its parent and other associated formatters. The inherited methods reflect and encompass the requirements of other venues within the hierarchy of the specific venue for the legal proceeding for which the case document was generated.

As an example, a formatter named “EasternDistrictOfCaliforniaFormatter” that encompasses the rules for the United States District Court for the Eastern District of California is itself a subclass of a formatter named “CaliforniaDistrictCourtFormatter” that encompasses the rules for all United States District Courts located in California. Furthermore, the “CaliforniaDistrictCourtFormatter” formatter is itself a subclass of a formatter named “DistrictCourtFormatter” that encompasses the rules for all United States District Courts. Moreover, the “DistrictCourtFormatter” formatter is itself a subclass of a formatter named “Formatter” that encompasses the general rules applicable to all formatters.

Once the procedural component of the selected formatter has been customized, the declarative component, in step 603, selects individual declarative stylesheet specification files which will be combined and rendered into a stylesheet that is to be applied to the HTML file version of the case document. The structure of the composite declarative stylesheet specification file also reflects the hierarchal structure of the selected formatter.

In a preferred embodiment, the association between a formatter and its corresponding declarative stylesheet specification file is implemented by a method included within the selected formatter. Specifically, each formatter constructs a filename for a corresponding declarative stylesheet specification file based on the name of the formatter. As an example, an instance of the formatter “EasternDistrictOfCaliforniaFormatter” has a corresponding declarative stylesheet specification file named “eastern_district_of_california_formatter.css.scss.” As such, once a formatter hierarchy has been implemented, it is easily determined which corresponding individual declarative stylesheet specification files need to be included into the selected formatter.

There may be a base group of declarative stylesheet specification files used by all formatters to render a final stylesheet. These base declarative stylesheet specification files may include a “page” declarative stylesheet specification, a “formatter” declarative stylesheet specification and a “vars” declarative stylesheet specification. The “page” declarative stylesheet specification contains general rules for pages, margins, headers, footers and page numbering. The “formatter” declarative stylesheet specification contains general rules applicable to all formatter types which relate to text layout, page breaks and general typography. The “vars” declarative stylesheet specification contains a set of default variable values for a given hierarchy group. As an example, there is a set of default variable values specific to the formatter subclass for all United States District Courts and a separate set of variable default values specific to the formatter subclass for United States Circuit Court of Appeals.

Next, in step 604, the individual declarative stylesheet specification files associated with the selected formatter invoke methods of the formatter to acquire values for variables defined within the individual declarative stylesheet specification files. Moreover, the invoked method may overwrite variable definitions made by other included individual declarative stylesheet specification.

Although the declarative and the procedural hierarchies within a formatter are distinct, it is possible for the procedural component of the formatter to influence the construction of a final declarative stylesheet specification in two ways.

First, a stylesheet can be provided by the procedural component of a formatter directly. As an example, a user customization might involve the inclusion of a custom stylesheet. This custom stylesheet may be inserted into the content of the HTML case document file as an inline stylesheet. Alternatively, the custom stylesheet might be composited into a final declarative stylesheet specification as part of the construction process of that final declarative stylesheet specification.

Secondly, templates which actually generate declarative stylesheet specification files may call methods within a formatter to generate content and dynamic formatting rules that are then included within the declarative stylesheet specification file. As such, effects are accomplished which would not be possible using only the underlying language of the declarative stylesheet specification.

At the simplest level, this interaction allows the values for variables defined within a declarative stylesheet specification file to be supplied directly by the procedural component of the formatter. In the same way that individual declarative stylesheet specification files can override defaults provided by more general declarative stylesheet specification files, those overridden values can themselves be derived from the procedural component of the formatter and from the case document itself. As an example, consider that font size and line height might be modified based on the case document's length. As a result, if it is necessary to fit the content of a case document within a fixed number of pages, the formatter may use information extracted from the case document itself and perform calculations which influence the formatting rules generated by the declarative stylesheet specification.

Similarly, in step 605, the individual declarative stylesheet specification files associated with the selected formatter invoke methods within that formatter to provide custom rules to be defined within the composite declarative stylesheet specification file.

Lastly, in step 606, the composite declarative stylesheet specification file generates one or more stylesheets which are combined and imported into the final HTML case document file. The final HTML case document file is then rendered into a final PDF file version of the case document.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention.

What is claimed:

1. A case document generating system for generating case documents in conjunction with a legal proceeding such that the generated case documents are formally correct according to the rules of a venue for the legal proceeding, the system comprising:
a computer processor configured for managing the generation of case documents including a web services module, a document renderer module, a document publishing module and a document archiving module; and
a database coupled to and configured to cooperate with the computer processor to store and retrieve the case documents and any components comprising or relating to the case document;
wherein the web service module provides for a web based editor that provides for the opening of a case document existing in the database, creating a new case document in the database, editing the case document and saving the case document in the database as an HTML file along with any components comprising or relating to the case document;
wherein the document renderer module provides for the rendering of the HTML file version of the case document into a final PDF file version of the case document file that is formally correct in accordance with the rules of the venue for the legal proceeding;
wherein the document publishing module provides for delivery of the final PDF file version of the case document which the user may download or which may be electronically filed directly with the venue of the legal proceeding or with a party related to the legal proceeding; and
wherein the document archiving module provides for the long term storage and retrieval of the case document, including the final PDF file version of the case document, the HTML file version of the case document and any components comprising or relating to the case document.

2. The case document generating system as set forth in claim 1, wherein the web services module provides for the entry and saving within the HTML file version of the case document of textual content, formatting information for selected portions of the textual content, semantic tags which define and categorize selected portions of the textual content, citation information and case information corresponding to the case document.

3. The case document generating system as set forth in claim 1, wherein the web services module provides for versioning of the case document using corresponding HTML file versions of the case document.

4. The case document generating system as set forth in claim 1, wherein the web services module provides for the inclusion of citations within the case document using either semantic tags surrounding textual content comprising the components of a citation or inline references to a citation document stored in the database.

5. The case document generating system as set forth in claim 1, wherein the document renderer module is comprised of a formatter that includes a procedural component and a declarative component, the procedural component including methods that implement an object-object oriented class based hierarchy and the declarative component including declarative stylesheet specification files that implement an inclusion based hierarchy.

6. The case document generating system set forth in claim 5, wherein the formatter is selected such that the class based hierarchy of the procedural component and the inclusion based hierarchy of the declarative component each reflect the hierarchy of the venue for the legal proceeding.

7. The case document generating system set forth in claim 5, wherein the declarative stylesheet specification files define pre-processing language instructions that include rules and variables which render into one or more stylesheets that are then applied to the HTML file version of the case document in an inclusive manner.

8. The case document generating system set forth in claim 5, wherein the methods generate new content for inclusion into the case document using existing semantically tagged content within the case document, the generated new content being necessary for a formally correct case document according to the rules of the venue for the legal proceeding.

9. The case document generating system set forth in claim 7, wherein the generated new content includes a Table of Contents and a Table of Authorities.

10. The case document generating system set forth in claim 5, wherein the methods substitute citation references within the case document with concrete marked-up text defining the referenced citation, the content and format of the marked up text depending on the placement of the citation within the case document and the citation type.

11. The case document generating system set forth in claim 5, wherein the formatter operates on the case document using case information, textual content within the case document, semantic tags within the case document, citation information within the case document, citation references stored in the database, customization information provided by a user or a specific formatter, and a type of formatter selected.

12. The case document generating system set forth in claim 1, wherein the document publishing module operates on the case document using the HTML file version of the case document, one or more stylesheets generated by the document renderer module and a template which provides for specific format requirements which are to be applied to the case document.

13. The case document generating system set forth in claim 7, wherein the pre-processing language instructions within the declarative stylesheet specification files call methods within the procedural component of the formatter to set values for one or more variables within the declarative stylesheet specification files.

14. A case document generating method implemented by a computer processor for automatically generating formally correct case documents within an electronic network connecting a plurality of desktop and mobile clients to the computer processor, comprising:
presenting a user interface over the electric network for inputting information on a legal proceeding and for generating a case document in conjunction with the legal proceeding;
receiving information on the legal proceeding inputted into the user interface including the venue of the legal proceeding;
generating an HTML file version of the case document using information inputted into the user interface;
selecting a formatter to be applied to the HTML file version of the case document based on the venue for the legal proceeding;
applying the selected formatter to the HTML file version of the case document to generate a formatted HTML file version of the case document;
selecting a template to be applied to the formatted HTML file version of the case document; and
applying the selected template to the formatted HTML file version of the case document to generate a formally correct PDF file version of the case document.

15. The case document generating method as set forth in claim 14 wherein the step of presenting a user interface includes presenting a user interface that allows for the entry and storage of case information on the legal proceeding and allows for the creation, retrieval and amendment of the case document.

16. The case document generating method as set forth in claim 15 wherein the user interface further provides for the inputting of textual content into the case document and for the insertion of semantic tags into the case document.

17. The case document generating method as set forth in claim 16 wherein the user interface further provides for the insertion of citations references into the case document.

18. The case document generating method as set forth in claim 14 wherein the step of selecting a formatter includes the selection of a formatter specific to a venue which include one or more methods and stylesheets that reflect the content and formatting rules of the venue for the legal proceeding.

19. The case document generating method as set forth in claim 18 wherein the step of selecting a formatter further includes importing the methods and stylesheets of other formatters specific to venues within the hierarchal structure of the specific venue for the legal proceeding.

20. The case document generating method as set forth in claim 14 wherein the step of applying the selected formatter to the HTML file version of the case document includes implementing the one or methods of the selected formatter on the case document and applying the one or more stylesheets to the content within the case document.

21. The case document generating method as set forth in claim 20 wherein the implementation of one or more methods includes providing for the generation of new content to be inserted into the case document based on content and semantic tags existing within the case document.

22. The case document generating method as set forth in claim 14 wherein the step of generating a formally correct PDF file version of the case document includes generating header and footer information, inserting the generated header and footer information into appropriate locations within the case document and inserting sufficient line breaks to provide for proper line and page spacing with the formatted case document.

23. The case document generating method as set forth in claim 20 wherein the implementation of one or more methods includes identifying references to citations within the case document and substituting those identified references to citations with actual citation information.
